(19) United States
(12) Patent Application Publication
(10) Pub. No.: US 2018/0030289 A1
(43) Pub. Date: Feb. 1, 2018

(54) INK FOR LASER IMAGING

(71) Applicant: DataLase Ltd., Widnes Cheshire (GB)

(72) Inventors: Anthony Jarvis, Widnes Cheshire (GB); Martin Walker, Widnes Cheshire (GB); Adam O'Rourke, Widnes Cheshire (GB)

(21) Appl. No.: 15/552,898

(22) PCT Filed: Feb. 23, 2016
(86) PCT No.: PCT/GB2016/050447

§ 371 Date: Aug. 23, 2017

(30) Foreign Application Priority Data
Feb. 23, 2015 (GB) 1502935.8

(51) Int. Cl. C09D 11/037; B41M 5/333; C08J 3/28; B41M 5/28; C09D 11/50; C08K 3/04

(52) U.S. Cl. CPC C09D 11/037; C09D 11/50; C08K 3/042; C08J 3/28; B41M 5/282; B41M 5/3338; C08J 2400/00

(57) ABSTRACT

Ink formulations and methods of using the same in laser-imaging are provided. An ink formulation can comprise a graphene-based component, a colour change agent, a binder, and a solvent. Substrates, coatings, and articles comprising a graphene-based component are also provided, and laser marking can be brought about by an ablation or direct charring process.

### FIELD OF THE INVENTION

This invention relates to laser imaging.

### BACKGROUND OF THE INVENTION

The use of ‘black body’ carbon based heat or near infrared (NIR) absorbers in laser marking processes is well known. However, often their NIR absorptivity is not sufficiently high for high contrast images to be achieved. This problem can be overcome by using more absorber or delivering more laser power but this in turn results in substrates/backgrounds becoming too darkly coloured, or substrates becoming unacceptably damaged during laser marking.

Therefore, one object of the invention is to provide an ink formulation for laser imaging that results in high contrast images. A further object of the invention is to provide an ink formulation for laser imaging that results in a low level of background colour formation.

It has been surprisingly found that a form of carbon known as graphene can be added to a colour change ink formulation and give superior performance compared to an equivalent amount of traditional carbon black.

### SUMMARY OF THE INVENTION

In a first aspect, the invention provides an ink formulation comprising:

(a) a graphene-based component,
(b) a colour change agent,
(c) a binder, and
(d) a solvent.

In a second aspect, the invention also relates to a substrate coated with an ink formulation according to the invention.

In a third aspect, the invention provides a method of providing an image on a substrate comprising:

(a) applying an ink formulation according to the invention to the substrate to form a coating; and
(b) exposing at least part of the coating to electromagnetic radiation so as to form an image. The ink formulations according to the invention have been found to have good laser imaging efficacy.

In a fourth aspect, the invention provides an article comprising a graphene-based component and a colour change agent, both of which are embedded into the article. An image may be provided on the article by exposing at least part of the article to electromagnetic radiation so as to form an image.

In a fifth aspect, the invention provides a thermoplastic substrate having a graphene-based component embedded into the article. The thermoplastic substrate may be heated by exposing at least part of the article to electromagnetic radiation.

### DESCRIPTION OF PREFERRED EMBODIMENTS

### Graphene-Based Component

The graphene-based component is added to absorb laser radiation and convert it into conductive heat, which then drives the colour change reaction to give a contrasting mark.

Graphene is a form of carbon consisting of planar sheets which are one atom thick, with the atoms arranged in a honeycomb-shaped lattice.

The term ‘graphene-based component’ as used herein includes all types of graphene and all derivatives of graphene thereof including, but not limited to: graphene oxide and reduced graphene oxide, chemically modified graphene, doped graphenes, e.g. P and N-doped types, and similar doped graphene oxides, halogenated graphenes, e.g. fluorographene.

The term ‘graphene-based component’ also includes all types of functionalised graphene whereby at least one other species has been grafted, either covalently or non-covalently, onto the graphene units. These other species can be organic species such as molecules and polymers, or inorganic species such as metal and metal oxide particles.

The graphene-based component may comprise particles in the range 0.001 micron to 20,000 microns. Preferably 0.005 micron to 50 microns, more preferably 0.01 micron to 30 microns, and even more preferably 0.1 micron to 25 microns.

The graphene-based component can be produced using any method known to the person skilled in the art. Examples include: liquid phase/solution and thermal exfoliation, chemical vapour deposition, synthesis on SiC, mechanical exfoliation, molecular assembly, and chemical reduction of graphite oxide or via carbon nanotube unzipping.

Further information on graphene synthesis is described in

### Graphene: Synthesis and Applications, Editors: Wonbong Choi, Jo-won Lee CRC Press, 2011, ISBN: 9781439861875.

### Graphene: Synthesis, Properties, and Phenomena, Editors: C. N. R. Rao, Ajay K. Sood, Wiley, 2013, ISBN: 9783527651153.

### Graphene: Synthesis and Applications, Authors Mohammad Hakimi, Paransa Alimard, LAP Lambert Academic Publishing, 2012, ISBN 9783844328486.

Graphene-based components can be purchased from:

### Graphene Laboratories Inc. 4603 Middle Country Rd Unit 125 Calverton, N.Y., 11933 USA;

### Graphenea Avenida de Tolosa, 76 20018—Donostia/San Sebastián Spain

### Applied Graphene Materials plc The Wilton Centre, Redcar Cleveland TS10 4RF, UK.

### Haydale Limited Reading Enterprise Centre, Reading University Campus, Earley Gate, Reading RG6 6BU, UK.

### Angstron Materials Inc 1240 McCook Avenue Dayton, Ohio 45404 USA.

### CVD Materials Corporation, 355 S. Technology Drive, Central Islip, N.Y. 11722, USA.

### Stanford Advanced Materials 72 Fairbanks Suite 100 Irvine, Calif. 92618 USA.

### Abalonyx AS Forskningsveien 1 0373 Oslo, Norway

Thomas Swan & Co. Ltd. Rotary Way Consett County Durham DH8 7ND UK.

### Graphene Platform Corp, Ebisu Minami 1-15-1 Shibuya-ku 150-0022 Tokyo Japan

Versarien plc, Building 4 Vantage Point Business Village Mitcheldean Gloucestershire GL17 0DD UK.

### Adnano Technolgies, Karnataka, India.

### Advanced Graphene Products Sp. z oo UI. Zeromskiego 19/1 65-066 Zielona Gora, Poland.

### AMO GmbH, Otto-Blumenthal-Straβe 25 52074 Aachen, Germany.

The particles can be of any particular shape or morphology, e.g. spheroidal, rods, ribbons, whiskers, wires, fibres, horns, sheets, stars, films, flakes, tubes including both single wall and multi-wall tubes, or platelets. The graphene-based component can be single-layer, few-layer or multi-layer. The graphene-based component can be nano sized. These are particularly preferred for forming coatings of high transparency.

A particularly preferred graphene-based component is graphene in the form of nano platelets. More preferred are graphene nano platelets with a thickness of ≦1000 nm and a width of ≦100 microns. More preferred still those graphene nano platelets with a thickness in the range 1 to 100 nm and width 5 to 50 microns. The thickness and width of the nano platelets may be measured by any suitable technique known to the skilled person, including, for example, by electron microscopy.

The surface area of the graphene nano platelets can be in the range 0.1 to 1,000 m²/g. The graphene based component is present in the ink formulation in the concentration range 0.1 to 20% w/w, preferably 0.25 to 10%, and more preferably still 0.5 to 5%.

### Colour Change Agent

The colour change agent can generate colour in response to an energy source. Preferably, the colour change agent is an irreversible colour change agent. However, reversible colour change agents are also within the scope of the present invention.

The term “irreversible” means that the colour, once generated, cannot be deliberately erased and then re-coloured. The colour can change into another colour, but it cannot be made to return to a colourless state or its original colour, and then converted back again to the initial generated colour.

The term “irreversible” does exclude the possibility that colour may fade gradually on exposure to background environmental conditions such as sunlight.

The colour change agent can be an inorganic metal oxyanion compound such as a molybdate, tungstate or chromate, preferably wherein the cation is an alkali metal or an alkaline earth metal or ammonium. One example is sodium molybdate. Particularly preferred are ammonium salts of metal oxyanions. Most preferably, the colour change agent is ammonium octamolybdate. Further suitable examples are taught in WO 02/074548.

The colour change agent can be an organic colour former. Examples include leuco dyes. These can be photochromic, which change colour on exposure to light such as UV light, or halochromic, which change colour on exposure to changes in environmental pH. Halochromic organic colour formers can be used in combination with a colour developer such as a lewis acid compound, or acid generating agent such as a thermal acid generating agent, particularly an irreversible thermal acid generating agent.

Examples of organic halochromic colour formers include those that are based on triphenylmethane, fluorans, phenothiazines, auramines, spiropyrans and indolinophthalides. Particularly preferred are black halochromic colour formers.

Examples of suitable leuco dyes are listed below:
2-anilino-3-methyl-6-dibutylaminofluoran,
3,3-bis(p-dimethylaminophenyl)-phthalide,
3,3-bis(p-dimethylaminophenyl)-6-dimethylaminophthalide (otherwise called “crystal violet lactone”),
3,3-bis(p-dimethylaminophenyl)-6-diethylaminophthalide,
15 3,3-bis(p-dimethylaminophenyl)-6-chlorophthalide,
3,3-bis(p-dibutylaminophenyl)phthalide,
3-cyclohexylamino-6-chlorofluoran,
3-dimethylamino-5,7-dimethylfluoran,
3-diethylamino-7-chlorofluoran,
3-diethylamino-7-methylfluoran,
3-diethylamino-7,8-benzofluoran,
3-diethylamino-6-methyl-7-chlorofluoran,
3-(N-p-tolyl-N-ethylamino)-6-methyl-7-anilinofluoran,
2-[N-(3′-trifluoromethylphenyl)amino]-6-diethylaminofluoran,
2-[3,6-bis(diethylamino)-9-(o-chloroanilino)xanthylbenzoic acid lactam],
3-diethylamino-6-methyl-7-(m-trichloromethylanilino)fluoran,
3-diethylamino-7-(o-chloroanilino)fluoran,
3-pyrrolidino-6-methyl-7-anilinofluoran,
3-di-n-butylamino-7-o-chloroanilinofluoran,
3-N-methyl-N,n-amylamino-6-methyl-7-anilinofluoran,
3-N-methyl-N-cyclohexylamino-6-methyl-7-anilinofluoran,
3-diethylamino-6-methyl-7-anilinofluoran,
3-(N,N-diethylamino)-5-methyl-7-(N,N-dibenzylamino)fluoran, benzoyl leuco methylene blue,
6′-chloro-8′-methoxy-benzoindolino-spiropyran,
6′-bromo-3′-methoxy-benzoindolino-spiropyran,
3-(2′-hydroxy-4′-dimethylaminophenyI)-3-(2′-methoxy-5′-chlorophenyl)phthalide,
3-(2′-hydroxy-4′-dimethylaminophenyI)-3-(2′-methoxy-5′-nitrophenyl)phthalide,
3-(2′-hydroxy-4′-diethylaminophenyl)-3-(2′-methoxy-5′-methylphenyl)phthalide,
3-(2′-methoxy-4′-dimethylaminophenyl)-3-(2′-hydroxy-4′-chloro-5′-methylphenyl)phthalide,
3-(N-ethyl-N-tetrahydrofurfuryl)amino-6-methyl-7-anilinofluoran,
3-N-ethyl-N-(2-ethoxypropyl)amino-6-methyl-7-anilinofluoran,
3-N-methyl-N-isobutyl-6-methyl-7-anilinofluoran,
3-morpholino-7-(N-propyl-trifluoromethylanilino)fluoran,
3-pyrrolidino-7-trifluoromethylanilinofluoran,
3-diethylamino-5-chloro-7-(N-benzyl-trifluoromethylanilino)fluoran,
3-pyrrolidino-7-(di-p-chlorophenyl)methylaminofluoran,
3-diethylamino-5-chloro-7-(a-phenylethylamino)fluoran,
3-(N-ethyl-p-toluidino)-7-(a-phenylethylamino)fluoran,
3-diethylamino-7-(o-methoxycarbonylphenylamino)fluoran,
3-diethylamino-5-methyl-7-(a-phenylethylamino)fluoran,
3-diethylamino-7-piperidinofluoran,
2-chloro-3-(N-methyltoluidino)-7-(p-n-butylanilino)fluoran,
3-di-n-butylamino-6-methyl-7-anilinofluoran,
3,6-bis(dimethylamino)fluorenespiro(9,3′)-6′-dimethylaminophthalide,
3-(N-benzyl-N-cyclohexylamino)-5,6-benzo-7-a-naphthylamino-4′-bromofluoran, 3-diethylamino-6-chloro-7-anilinofluoran,
3-diethylamino-6-methyl-7-mesitydino-4′,
5′-benzofluoran,
3-N-methyl-N-isopropyl-6-methyl-7-anilinofluoran,
3-N-ethyl-N-isoamyl-6-methyl-7-anilinofluoran,
3-diethylamino-6-methyl-7-(2′,4′-dimethylanilino)fluoran,
3-morpholino-7-(N-propyl-trifluoromethylanilino)fluoran,
3-pyrrolidino-7-trifluoromethylanilinofluoran,
3-diethylamino-5-chloro-7-(N-benzyl-trifluoromethylanilino)fluoran,
3-pyrrolidino-7-(di-p-chlorophenyl)methylaminofluoran,
3-diethylamino-5-chloro-([alpha]-phenylethylamino)fluoran,
35 3-(N-ethyl-p-toluidino)-7-([alpha]-phenylethylamino)fluoran,
3-diethylamino-7-(o-methoxycarbonylphenylamino)fluoran,
3-diethylamino-5-methyl-7-([alpha]-phenylethylamino)fluoran,
3-diethylamino-7-piperidinofluoran,
2-chloro-3-(N-methyltoluidino)-7-(p-N-butylanilino)fluoran,
3,6-bis(dimethylamino)fluorenspiro(9,3′)-6′-dimethylaminophthalide,
3-(N-benzyl-N-cyclohexylamino)-5,6-benzo-7-a-naphthylamino-4′-bromofluoran, 3-diethylamino-6-chloro-7-anilinofluoran,
3-N-ethyl-N-(2-ethoxypropyl)amino-6-methyl-7-anilinofluoran,
3-N-ethyl-N-tetrahydrofurfurylamino-6-methyl-7-anilinofluoran,
3-diethylamino-6-methyl-7-mesitydino-4′,5′-benzofluoran,
3-(p-dimethylaminophenyI)-3-[1,1-bis(p-dimethylaminophenyl)ethylene-2-yl]phthalide,
3-(p-dimethylaminophenyl)-3-[1,1-bis(p-dimethylaminophenyl)ethylene-2-yl]-6-dimethylaminophthalide,
3-(p-dimethylaminophenyl)-3-(1-p-dimethylaminophenyl-1-phenylethylene-2-yl)phthalide,
3-(p-dimethylaminophenyl)-3-(1-p-dimethylaminophenyl-1-p-chlorophenylethylene-2-yl)-6-dimethylaminophthalide,
3-(4′-dimethylamino-2′-methoxy)-3-(1″-p-dimethylaminophenyl-1″-p-chlorophenyl-1″3″-butadiene-4″-yl)benzophthalide,
3-(4′-dimethylamino-2′-benzyloxy)-3-(1″-p-dimethylaminophenyl-1″-phenyl-1″, 3″-butadiene-4″-yl)benzophthalide,
3-dimethylamino-6-dimethylamino-fluorene-9-spiro-3′-(6′-dimethylamino)phthalide,
3,3-bis-[2-(p-dimethylaminophenyl)-2-(p-methoxyphenyl)ethenyl]-4,5,6,7-tetrachlorophthalide,
3-bis[1,1-bis(4-pyrrolidinophenyl)ethylene-2-yl]-5,6-dichloro-4,7-dibromophthalide,
bis(p-dimethylaminostyryl)-1-naphthalenesulfonylmethane, and
bis(p-dimethylaminostyryl)-1-p-tolylsulfonylmethane.

These may be used individually or in combination.

Particularly preferred halochromic leuco dyes are: 3′-(N-Ethyl-p-tolylamino)-6′-methyl-7′-anilinofluoran (also known as ETAC, CAS: 59129-79-2), 2-anilino-6-dibutylamino-3-methylfluoran (also known as Pergascript Black 2C, CAS: 89331-94-2), and 2-anilino-3-methyl-6-diethylaminofluoran (also known as Pergascript Black 10, CAS: 29512-49-0), which are preferably included in a concentration from 2 to 35% w/w.

Examples of thermal acid generating agents include the boron and silicon based complex ammonium salt compounds as taught in WO2006/108745.

Preferred examples of these are those based on complexes formed between boron and salicylic acid, and a particularly preferred example of such a compound is the tributyl ammonium salt version: tri-n-butylammonium borodisalicylate; and the compound N-(p-Toluenesulfonyl) N′-(3-p-toluenesulfonyloxyphenyl) urea (Pergafast 201, ex. BASF). Other examples include “onium” type compounds such as sulphonium and iodonium salts. Further examples of colour developers are taught in WO2010/049281. Other thermal acid generators include derivatives of phenol such as: benzyl p-hydroxylbenzoate and bis-Phenol A.

The most preferred Lewis acid type colour developers are zinc salts, particularly zinc salts of aliphatic or aromatic carboxylic acids, such as zinc stearate, zinc salicylate, and zinc benzoate and derivatives thereof.

The colour change agent can be a compound that comprises a diacetylene or —C≡C—C≡C— group. Particularly preferred are those diacetylenes that are activatable. ‘Activatable’ means that the diacetylene is are made in a form that is initially unreactive to UV light but can be converted into a form reactive to UV light by for example heating and cooling, or melt-recrystalisation. The diacetylene could be reversibly or irreversibly activatable.

Suitable examples are taught in WO2009/093028, WO2010/001171, WO2011/08944, WO2010/029329 and also the unpublished application, GB1420831.8.

In the final substrate there can be more than one type of colour change agent present, and they can be located within the same layer or in multiple layers. The colour change agent can also be a charge transfer compound such as a carbazole, which can be used in combination with an acid generating agent.

In another embodiment, the colour change agent is a charrable agent. The charrable agent can be any substance that undergoes a charring reacting on heating to yield a contrasting colour. Suitable examples of charrable agents are compounds that typically contain a high content of carbon and oxygen. Typically, the charrable agent contains at least one hydroxyl group. Preferably the charrable agent is a carbohydrate. Examples of suitable carbohydrates include saccharides, polysaccharides, sugars, polysugars and wherein the carbonyl group has been reduced to a hydroxyl group, to give a sugar alcohol, starches, celluloses, gums and the like.

Examples include but are not limited to glucose, sucrose, saccharose, fructose, dextrose, lactose, sorbitol, xylitol, pectin, mannitol, manitose, erythritol, galactose, cellobiose, mannose, arabinose, ribose, erythrose, xylose, cyclodextrin, meso-erythritol, pentaerythritol, indulin, dextrin, polydextrose, maltose, maltodextrin of any DE, corn syrups, starch, amylose, amylopectin, pectic acid, cellulose and cellulose derivatives such as such as sodium-CMC, and hydroxypropylcellulose, galactomannans, guar gum, locust bean gum, gum arabic and the like. Other examples of charrable agents include amino acids, amino sugars such as glucosamine, chitin and chitosan, alginates as taught in WO06/129086, gluconates and malonates as taught in WO06/129078, any of the charrable chemistries which undergo an elimination reaction as taught in WO02/068205 such as poly(vinyl alcohol) and poly(vinyl chloride). Further examples of charrable agents are taught in WO08/107345 and EP2468524.

In a preferred embodiment, the charrable agent is used in combination with an acid or base generating agent such as a metal salt.

The colour change agent, or combination thereof, is typically present in the ink formulation in the concentration range 0.1 to 60% w/w, preferably 10 to 50%.

### Microencapsulation

Any component of the coating or ink of the present invention, such as the graphene-based component or any of the colour change agents, can be present either unencapsulated or in a microencapsulated form.

### Binder

The binder can be any suitable binder. Preferably, the binder is a polymeric binder. Examples of polymeric binders are acrylic polymers, styrene polymers and hydrogenated products thereof, vinyl polymers, polyolefins and hydrogenated or epoxidized products thereof, aldehyde polymers, epoxide polymers, polyamides, polyesters, polyurethanes, sulfone-based polymers and natural polymers and derivatives thereof. The polymeric binder can also be a mixture of polymeric binders.

Acrylic polymers are polymers formed from at least one acrylic monomer or from at least one acrylic monomer and at least one styrene monomer, vinyl monomer, olefin monomer and/or maleic monomer. Examples of acrylic monomers are acrylic acid or salts thereof, acrylamide, acrylonitrile, C₁₋₆alkyl acrylates such as ethyl acrylate, butyl acrylate or hexyl acrylate, di(C₁₋₄-alkyl-amino)Ci-6-alkyl acrylates such as dimethylaminoethyl acrylate or diethylaminoethyl acrylate and C₁₋₄-alkyl halide adducts thereof such as dimethylaminoethyl acrylate methyl chloride, amides formed from di(C₁₋₄-alkylamino)C₁₋₆-alkylamines and acrylic acid and C₁₋₄-alkyl halide adducts thereof, methacrylic acid or salts thereof, methacrylamide, methacrylonitrile, C₁₋₆-alkyl methacrylates such as methyl methacrylate or ethyl methacrylate, di(C₁₋₄-alkyl-amino)C₁₋₆-alkyl methacrylates and C₁₋₄-alkyl halide adducts thereof, amides formed from di(C₁₋₄-alkylamino)C₁_{_}₆-alkylamines and methacrylic acid and C₁₋₄-alkyl halide adducts thereof and crosslinker such as N,N′-Methylenebisacrylamide.

Examples of styrene monomers are styrene, 4-methylstyrene and 4-vinylbiphenyl. Examples of vinyl monomers are vinyl alcohol, vinyl chloride, vinylidene chloride, vinyl isobutyl ether and vinyl acetate. Examples of olefin monomers are ethylene, propylene, butadiene and isoprene and chlorinated or fluorinated derivatives thereof such as tetrafluroethylene. Examples of maleic monomers are maleic acid, maleic anhydride and maleimide.

Examples of acrylic polymers are poly(methyl methacrylate), poly(butyl methacrylate) and styrene acrylic polymers.

Styrene polymers are polymers formed from at least one styrene monomer and at least one vinyl monomer, olefin monomer and/or maleic monomer. Examples of styrene monomers, vinyl monomers, olefin monomers and maleic monomers are given above. Examples of styrene polymers are styrene butadiene styrene block polymers, styrene ethylene butadiene block polymers, styrene ethylene propylene styrene block polymers.

Vinyl polymers are polymers formed from at least one vinyl monomer or from at least one vinyl monomer and at least one olefin monomer or maleic monomer. Examples of vinyl monomers, olefin monomers and maleic monomers are given above. Examples of vinyl polymers are polyvinyl chloride and polyvinylalcohol.

Polyolefins are polymers formed from at least one olefin monomer. Examples of olefin monomers are ethylene, propylene, butadiene and isoprene and chlorinated or fluorinated derivatives thereof such as tetrafluroethylene. Examples of polyolefines are polyethylene, polypropylene and polybutadiene.

Aldehyde polymers are polymers formed from at least one aldehyde monomer or polymer and at least one alcohol monomer or polymer, amine monomer or polymer and/or urea monomer or polymer. Examples of aldehyde monomers are formaldehyde, furfural and butyral. Examples of alcohol monomers are phenol, cresol, resorcinol and xylenol. An example of polyalcohol is polyvinyl alcohol. Examples of amine monomers are aniline and melamine. Examples of urea monomers are urea, thiurea and dicyandiamide. An example of an aldehyde polymer is polyvinyl butyral formed from butyral and polyvinylalcohol.

Epoxide polymers are polymers formed from at least one epoxide monomer and at least one alcohol monomer and/or amine monomer. Examples of epoxide monomers are epichlorhydrine and glycidol. Examples of alcohol monomers are phenol, cresol, resorcinol, xylenol, bisphenol A and glycol. An example of epoxide polymer is phenoxy resin, which is formed from epichlorihydrin and bisphenol A.

Polyamides are polymers formed from at least one monomer having an amide group or an amino as well as a carboxy group or from at least one monomer having two amino groups and at least one monomer having two carboxy groups. An example of a monomer having an amide group is caprolactam. An example of a diamine is 1,6-diaminohexane. Examples of dicarboxylic acids are adipic acid, terephthalic acid, isophthalic acid and 1,4-naphthalene-dicarboxylic acid. Examples of polyamides are poyhexamethylene adipamide and polycaprolactam.

Polyesters polymers formed from at least one monomer having an hydroxy as well as a carboxy group or from at least one monomer having two hydroxy groups and at least one monomer having two carboxy groups or a lactone group.

An example of a monomer having a hydroxy as well as a carboxy group is adipic acid. An example of a diol is ethylene glycol. An example of a monomer having a lactone group is carprolactone. Examples of dicarboxylic acids are terephthalic acid, isophthalic acid and 1,4-naphthalenedicarboxylic acid. An example of polyesters is polyethylene terephthalate. So-called alkyd resins are also regarded to belong to polyester polymers. Polyurethane are polymers formed from at least one diisocyanate monomer and at least one polyol monomer and/or polyamine monomer. Examples of diisocyanate monomers are hexamethylene diisocyanate, toluene diisiocyanate and diphenyl methane diiscocyanate.

Examples of sulfone-based polymers are polyarylsulfone, polyethersulfone, polyphenyl-sulfone and polysulfone. Polysulfone is a polymer formed from 4,4-dichlorodiphenyl sulfone and bisphenol A. Natural polymers can be a cellulose, natural rubber or gelatin. Examples of cellulose derivatives are ethyl cellulose, hydroxypropyl cellulose, nitrocellulose, cellulose acetate and cellulose propionate.

The polymeric binders are known in the art and can be produced by known methods. The polymeric binder can be also produced in situ by UV radiation of a composition comprising monomers, capable of radical polymerisation, and a UV sensitive initiator.

Preferred polymeric binders are acrylic polymers, vinyl polymers, aldehyde polymers, epoxide polymers, polyamides, polyesters and natural polymers and derivatives thereof. More preferred polymeric binders acrylic polymers, vinyl polymers, natural polymers and derivatives thereof.

Even more preferred polymeric binders are poly(methyl methacrylate), poly(butyl methacrylate), polyvinyl alcohol and cellulose. Particularly preferred binders are styrene-acrylic or styrene-acrylate copolymers.

The binder is typically present in an amount of 0.1-60% w/w.

Examples of suitable binders can be found in the Joncryl range supplied by BASF.

### Solvent

The ink formulation contains a solvent. The solvent can be any suitable solvent. Suitable solvents include: water, organic solvents, mixtures of organic solvents and mixtures of one or more organic solvent with water. Preferably, the solvent is water, an organic solvent, a mixture of organic solvents or a mixture of one or more organic solvent with water. More preferably, where the solvent comprises an organic solvent or a mixture of organic solvents, the organic solvent or solvents are preferably selected from the group consisting of C₁₋₄-alkanols, C₁₋₄-polyols, C₁₋₄-alkyl C₁₋₄-alkanoates, C₃₋₆-ketones, C₄₋₆-ethers, C₂₋₃-nitriles, nitromethane, dimethylsulfoxide, dimethylformamide, dimethylacetamide, N-methylpyrolidone and sulfolane, whereby C₁₋₄-alkanols, C₁₋₄-polyols and C₁₋₄-alkyl C₁₋₄-alkanoates may be substituted with C₁₋₄-alkoxy.

Examples of C₁₋₄-alkanols are methanol, ethanol, propanol, isopropanol or butanol, iso-butanol, sec-butanol and tert-butanol. Examples of a C₁₋₄-alkoxyderivatives thereof are 2-ethoxyethanol and 1-methoxy-2-propanol. Examples of C₁₋₄-polyols are glycol and glycerol. Examples of C₁₋₄-alkyl C₁₋₄-alkanoates are ethyl acetate, butyl acetate, ethyl propionate and ethyl butanoate. Examples of C₁₋₄-alkoxy derivatives thereof are 2-ethoxyethyl acetate and 2-methoxyethyl acetate.

Examples of C₃₋₆-ketones are acetone and methyl ethyl ketone. Examples of C₄₋₆-ethers are dimethoxyethane, diisopropylethyl and tetrahydrofurane. An example of a C₂₋₃-nitrile is acetonitrile. The organic solvent can be a liquid hydrocarbon such as a C5 to C18 hydrocarbon, such as pentane, hexane, heptane, octane or cyclic version such as cyclohexane.

Most preferably, the solvent is an organic solvent or a mixture of organic solvents selected from the group consisting of C₁₋₄-alkanols, C₁₋₄-alkyl C₁₋₄-alkanoates and C₃₋₆-ketones. Most preferably, the organic solvent is a C₃₋₆-ketone or a mixture of C₃₋₆-ketones. The solvent is typically present in the ink formulation in the concentration range 20 to 70%.

### Optional Components

Optional additional components of composition of the present invention can be any other compound suitable for improving the performance of the composition.

Examples of optional additional components are mid-IR absorbers, other NIR absorbers, UV absorbers, hindered amines, traditional dyes and pigments, stabilizers and antioxidants, whitening agents such as titanium dioxide, zinc compounds such as zinc oxide and zinc salt of carboxylic acids such as zinc stearate, basic salts such as sodium carbonate, retarders, plasticizers, adhesion promoters and rheology modifiers, flame retardants, biocides, surfactants, foam control agents, leuco dye sensitisers and de-sensitisers.

### Application of the Ink

The ink of the present invention can be applied to a substrate to form a coating using any suitable coating technique to any suitable substrate known in the printing industry. Suitable printing techniques include: litho, offset, pad, screen, gravure, flexographic and flood coating.

Substrate examples include paper, corrugated fiberboard, cardboard, polymer films such as PE, PP, BOPP, cellulose films and PET. The substrate can be a foodstuff or pharmaceutical preparation, metal, metallic foil, metallic tin/can, ridged plastic article, textile or leather. The ink of the present invention can be used to create a multi-layer construction that comprises more than two layers (the ink layer and the substrate layer). This can include other ink or coating layers, barrier layers to protect the laser sensitive layer from environmental factors such as light, air, pressure and friction, primer layers directly underneath the laser sensitive layer, or other functional layers to form a multilayer construction. Other functional layers include adhesive layers to form labels, backing layers such as glassine backing, upper release layers such as those formed by silicone based release lacquers, upper polymeric film layers particularly transparent polymeric films to form a tape construction. Particularly preferred types of adhesive in these examples are those that form pressure sensitive labels and tapes. For example a pressure sensitive adhesive backing layer in combination with an upper release layer to form a pressure sensitive NIR imageable laser label, or a pressure sensitive adhesive backing layer in combination with an upper transparent polymeric film layer to form a pressure sensitive NIR imageable tape.

In an embodiment the graphene-based component and colour change agent are embedded into the substrate, without the need for a coating process. This is particularly useful for paper-based and plastic-based substrates. An image may be provided on the substrate by exposing at least part of the substrate to electromagnetic radiation so as to form an image. In an embodiment the electromagnetic radiation has a wavelength in the range 200 nm to 20,000 microns. In an alternative embodiment, the radiation is near infrared radiation having a wavelength in the range 700 nm to 2,500 nm. In an embodiment the radiation is supplied by a laser such as a CO₂, fibre or YAG laser, or a diode or an array of such sources.

In an embodiment, the substrate comprises from 0.1 to 20% w/w of a graphene-based component.

In an embodiment, the substrate comprises from 0.1 to 60% w/w of a colour change agent.

In an embodiment the graphene-based component is embedded into a thermoplastic. The graphene-based component can be embedded into the thermoplastic using any suitable technique such as, for example, using an extrusion or injection moulding process. Embedding the graphene-based component into the thermoplastic is useful for increasing the ability of the plastic to absorb heat, for example in stretch blow moulding processes. In an embodiment, the thermoplastic substrate comprises from 0.1 to 20% w/w of a graphene-based component.

### Image Formation

After application of the ink of the invention to a suitable substrate, an image can be formed by exposing at least part of the coating to electromagnetic radiation using an energy source, such as a thermal print heat or light source. Preferably, the light source is a laser or laser array system. Most preferably, the electromagnetic radiation is supplied by a CO₂, fibre or YAG laser, or a diode or an array of such sources

Preferably, the electromagnetic radiation has a wavelength range 200 nm to 20,000 microns. More preferably, the radiation is near infrared radiation having a wavelength in the range 700 nm to 2,500 nm. The radiation can be monochromatic or broadband, coherent or non-coherent. Image formation can also occur using a direct contact thermal print head.

### EXAMPLES

A traditional carbon black as used in coatings was obtained from Cabot.
A sample of graphene nano platelets were obtained from Haydale, Carmarthenshire UK.

The following 4 ink formulations were prepared. Percentage quantities are determined by weight, i.e. w/w %.

### Solvent Based AOM Ink—Comparative Example 1 and Example 1

| | |
|---|---|
| Ethanol | 10% |
| Ethyl acetate | 28.8% |
| Nitrocellulose | 8% |
| Maleic resin | 5% |
| Ammonium octamolybdate | 35% |
| Polyurethane solution | 11% |
| Silica | 0.70% |
| Organic titanate solution | 1% |
| Comparative example 1 = traditional carbon black | 0.5% |
| Example 1 = graphene nanoplatelets | 0.5% |

Both inks were drawn down onto 50 micron white BOPP film using an RK-Coater fitted with a K2 bar.

### Water Based Leuco Dye Ink—Comparative Example 2 and Example 2

| | |
|---|---|
| 25% Aqueous styrene-acrylate resin solution, | 69.5% |
| monoethanolamine neutralised | |
| 7-Anilino-3-diethylamino-6-methylfluoran (black colour | 10% |
| forming leuco dye) | |
| Tributylammonium borodisalicylate (colour developer) | 18.5% |
| Defoamer | 1% |
| Comparative example 2 = traditional carbon black | 1% |
| Example 2 = graphene nanoplatlets | 1% |

Both inks were drawn down onto white fibreboard paper using an RK-Coater fitted with a K2 bar.

### Laser Imaging

Laser imaging was performed using a 1070 nm, 40 Watt, fibre laser controlled by an IBM compatible PC.

A series of fluence squares measuring 5×5 mm were created from 0 to approximately 5 Jcm⁻²

The background colour and black optical density of the squares was measured using an X-Rite SpectroEye.

### Results

Solvent based AOM ink—Optical density difference from 0 Jcm⁻² (ΔOD)

| Fluence | 0 | 0.5 | 1.0 | 1.5 | 2.0 | 2.5 | 3.0 | 3.5 | 4.0 | 4.5 | 5.0 |
|---|---|---|---|---|---|---|---|---|---|---|---|
| Comparative | 0 | 0.10 | 0.12 | 0.18 | 0.28 | 0.48 | 0.52 | 0.54 | 0.48 | 0.42 | 0.38 |
| Example 1 | | | | | | | | | | | |
| Example 1 | 0 | 0.15 | 0.15 | 0.22 | 0.48 | 0.56 | 0.58 | 0.68 | 0.58 | 0.48 | 0.40 |

Background colour=(ΔE versus uncoated substrate)

| CIELAB | L* | a* | b* | C | h° | ΔE |
|---|---|---|---|---|---|---|
| Comparative | 69.98 | −2.12 | −3.15 | 3.79 | 236 | 12.06 |
| Example 1 | | | | | | |
| Example 1 | 81.67 | −0.12 | −1.11 | 1.12 | 276 | 2.35 |

Water based leuco dye ink—Optical density difference from 0 Jcm⁻² (ΔOD)

| Fluence | 0 | 0.5 | 1.0 | 1.5 | 2.0 | 2.5 | 3.0 | 3.5 | 4.0 | 4.5 | 5.0 |
|---|---|---|---|---|---|---|---|---|---|---|---|
| Comparative | 0 | 0.10 | 0.14 | 0.20 | 0.32 | 0.38 | 0.46 | 0.56 | 0.72 | 0.60 | 0.2 |
| Example 1 | | | | | | | | | | | |
| Example 1 | 0 | 0.14 | 0.18 | 0.24 | 0.34 | 0.40 | 0.50 | 0.6 | 0.75 | 0.64 | 0.2 |

Background colour=(ΔE versus uncoated substrate)

| CIELAB | L* | a* | b* | C | h° | ΔE |
|---|---|---|---|---|---|---|
| Comparative | 66.53 | −2.60 | −1.40 | 4.30 | 216 | 25.55 |
| Example 1 | | | | | | |
| Example 1 | 77.47 | −0.04 | 1.97 | 1.97 | 91 | 13.78 |

1. An ink formulation comprising:
(a) a graphene-based component,
(b) a colour change agent,
(c) a binder, and
(d) a solvent.

2. The ink formulation according to claim 1, wherein the graphene-based component is graphene or a derivative thereof.

3. The ink formulation according to claim 2, wherein the graphene or a derivative thereof is in the form of spheroidal, rod, ribbon, whisker, wire, fibre, horn, sheet, star, film, flake, tube or platelet shaped particles.

4. The ink formulation according to claim 3, wherein the graphene or a derivative thereof particles are nano sized.

5. The ink formulation according to claim 1, wherein the colour change agent is a metal oxyanion, such as a metal or ammonium molybdate.

6-9. (canceled)

10. The ink formulation according to claim 1, wherein the colour change agent is a diacetylene.

11-13. (canceled)

14. The ink formulation according to claim 1, wherein the colour change agent is a leuco dye, optionally further comprising a colour developing agent.

15. The ink formulation according to claim 14, wherein the colour developing agent is a thermal acid generating compound.

16. (canceled)

17. The ink formulation according to claim 1, wherein the colour change agent is a charrable agent.

18-19. (canceled)

20. The ink formulation according to claim 17, further comprising a colour developing agent which is an acid or base generating agent.

21. A substrate coated with the ink formulation according to claim 1.

22. The substrate according to claim 21, where the substrate is cellulose-based such as paper, cardboard, corrugated fiberboard or cellulose film, plastic-based such as a ridged plastic article or a plastic film such as PE, PP, BOPP, PET, metal-based such as metallic foil, or a metallic tin/can, a textile, a foodstuff or a pharmaceutical preparation.

23. (canceled)

24. A method of providing an image on a substrate, the method comprising: (a) applying an ink formulation according to claim 1 to the substrate to form a coating; and (b) exposing at least part of the coating to electromagnetic radiation so as to form an image.

25. The method according to claim 24, wherein the electromagnetic radiation has a wavelength in the range 200 nm to 20,000 microns.

26. The method according to claim 25, wherein the radiation is near infrared radiation having a wavelength in the range 700 nm to 2,500 nm.

27. (canceled)

28. A substrate or coating comprising a graphene based component, whereby laser marking can be brought about by an ablation or direct charring process.

29. An article comprising a graphene-based component and a colour change agent, both of which are embedded into the article.

30. (canceled)

31. A method of providing an image on an article according to claim 29, the method comprising: exposing at least part of the article to electromagnetic radiation so as to form an image.

32. A thermoplastic article comprising a graphene-based component embedded therein.

33. A method of heating the thermoplastic article of claim 32 by exposing at least part of the article to electromagnetic radiation.

34-37. (canceled)
